(19) United States
(12) Patent Application Publication
(10) Pub. No.: US 2014/0223330 A1
(43) Pub. Date: Aug. 7, 2014

(54) PORTABLE ELECTRONIC DEVICE AND MULTI-DEVICE INTEGRATION METHOD THEREOF

(71) Applicant: HTC CORPORATION, Taoyuan City (TW)

(72) Inventors: Chin-Yu WANG, Taoyuan City (TW); Te-Mu CHEN, Taoyuan City (TW)

(73) Assignee: HTC CORPORATION, Taoyuan City (TW)

(21) Appl. No.: 13/757,281

(22) Filed: Feb. 1, 2013

(51) Int. Cl. H04L 12/24

(52) U.S. Cl. CPC H04L 41/22
USPC 715/751

(57) ABSTRACT

A portable electronic device and a multi-device integration method thereof are disclosed. A processor of the portable electronic device executing program codes of multi-device integration. According to the executed program codes, the portable electronic device is aligned and synchronized to at least one nearby portable electronic device and thereby the portable electronic device is integrated with the at least one nearby portable electronic device to perform a task associated with an alignment between the portable electronic device and the at least one nearby portable electronic device.

### BACKGROUND OF THE INVENTION

1. Field of the Invention

The present invention relates to portable electronic devices.

2. Description of the Related Art

Portable electronic devices, such as a Smartphone or a tablet computer, with advanced computing capacity are popular today. However, for mobile use, the size of a portable electronic device is limited and the limited-sized I/O interface (e.g., the small-sized screen or phone speaker) make the video/audio experience of the user uncomfortable.

### BRIEF SUMMARY OF THE INVENTION

Portable electronic devices capable of being integrated with each other for enlarged I/O interfaces are disclosed.

A portable electronic device in accordance with an exemplary embodiment of the invention comprises a communication unit, a storage media and a processor. The communication unit is provided for communication between the portable electronic device and at least one nearby portable electronic device. The storage media is stored with program codes of multi-device integration. The processor executes the program codes for alignment and synchronization between the portable electronic device and the at least one nearby portable electronic device, such that the portable electronic device is integrated with the at least one nearby portable electronic device to perform a task associated with the alignment between the portable electronic device and the at least one nearby portable electronic device.

Multi-device integration methods are disclosed as well.

In another exemplary embodiment of the invention, a multi-device integration method comprises the following steps: using a processor of a portable electronic device to execute program codes of multi-device integration; and, according to the executed program code, aligning and synchronizing the portable electronic device to the at least one nearby portable electronic device and thereby integrating the portable electronic device with the at least one nearby portable electronic device to perform a task associated with an alignment between the portable electronic device and the at least one nearby portable electronic device.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a block diagram depicting a portable electronic device 100 in accordance with an exemplary embodiment of the invention;

FIG. 2 depicts an enlarged screen composed of touch panels of 3×3 portable electronic devices of the disclosure;

FIG. 3 shows two portable electronic devices integrated for keyboard extension;

FIG. 4 shows three portable electronic devices integrated for a multimedia application;

FIG. 5 shows five portable electronic devices integrated for a 5.1 channel audio display;

FIG. 6A is a flowchart depicting an alignment method between the different portable electronic devices;

FIG. 6B shows the different alignment maps displayed on 3×3 portable electronic devices;

FIG. 7 shows a flowchart depicting another alignment method between the different portable electronic devices;

FIG. 8A shows how the position of a device is detected by a touch panel of the device;

FIG. 8B shows another exemplary embodiment of a portable electronic device, wherein each edge of the touch panel is disposed with a transmitter (e.g. 802, 804), to be detected by a touch panel of a nearby portable electronic device; and

FIG. 9 shows 3×3 images captured by cameras of portable electronic devices arranged in a 3×3 array.

### DETAILED DESCRIPTION OF THE INVENTION

The following description shows several exemplary embodiments carrying out the invention. This description is made for the purpose of illustrating the general principles of the invention and should not be taken in a limiting sense. The scope of the invention is best determined by reference to the appended claims.

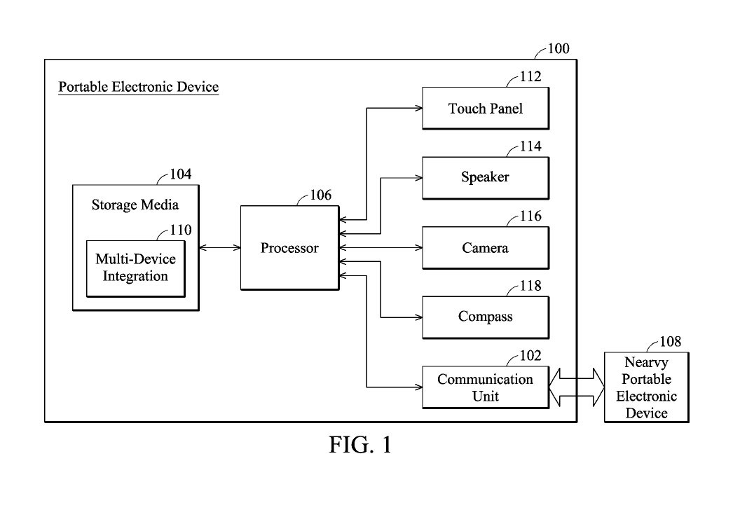

FIG. 1 is a block diagram depicting a portable electronic device 100 in accordance with an exemplary embodiment of the invention. The portable electronic device 100 comprises a communication unit 102, a storage media 104 and a processor 106. The communication unit 102 is provided for communication between the portable electronic device 100 and at least one nearby portable electronic device 108. The storage media 104 is stored with program codes 110 of multi-device integration. The processor 106 executes the program codes 110 for alignment and synchronization between the portable electronic device 100 and the at least one nearby portable electronic device 108, such that the portable electronic device 100 is integrated with the at least one nearby portable electronic device 108 to perform a task associated with the alignment between the portable electronic device 100 and the at least one nearby portable electronic device 108. The communication unit 102 provided for communication between the different portable electronic devices 100 and 108 may be a WiFi, 3G or Bluetooth communication unit and so on. As shown, the portable electronic device 100 may further comprise a touch panel 112, a speaker 114, a camera 116 and/or a compass 118. These components are controlled by the processor 106 and are discussed later.

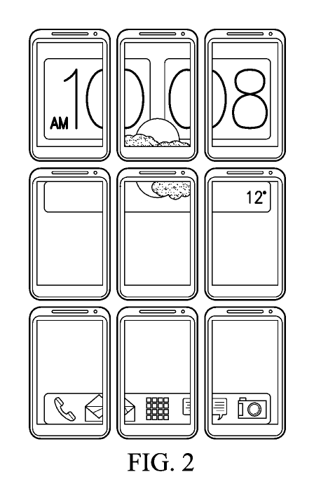

FIG. 2 depicts an enlarged screen composed of touch panels of 3×3 portable electronic devices of the disclosure. One of the 3×3 portable electronic devices may be a master device, e.g. the center one. By the processor of the master device, one complete frame may be divided into blocks to be displayed the different 3×3 portable electronic devices. Thus, the touch panel of the master device is integrated with touch panels of the nearby eight portable electronic devices for an enlarged screen.

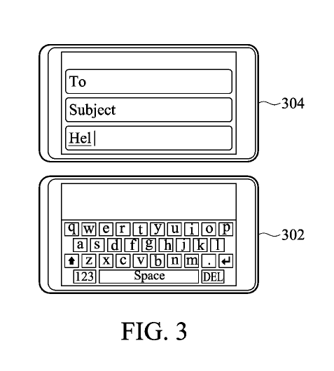

FIG. 3 depicts another exemplary embodiment of the invention, wherein the portable electronic device 302 is placed adjacent to the portable electronic device 304. The processor of the portable electronic device 304 may switch the touch panel of the device 304 to display a main screen only while the touch panel of the device 302 is driven to display a keyboard pattern. The portable electronic device 302 is integrated with the portable electronic device 304 for keyboard extension, and the device 302 works as an extended keyboard.

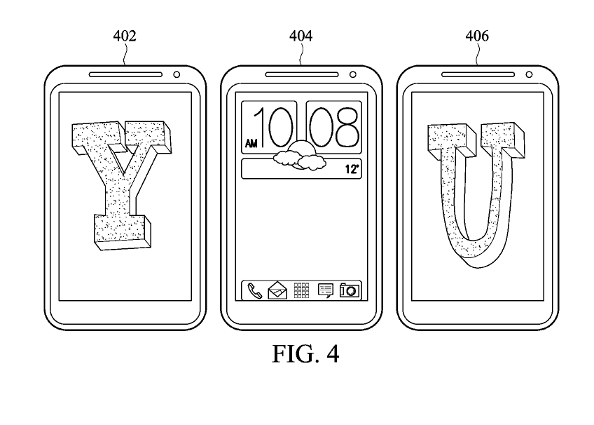

FIG. 4 depicts another exemplary embodiment of the invention, wherein portable electronic devices 402, 404 and 406 are placed one by one. The portable electronic device 404 may be a master device. The processor of the master device 404 may assign images, videos, or audios to be displayed by the devices 402, 404 and 406 and thereby the devices 402, 404 and 406 are integrated for multimedia applications. In FIG. 4, the touch panel of device 404 is driven to display a main screen and/or a master audio channel while the touch panels of the nearby portable electronic devices 402 and 404 are driven to display sub screens and/or sub-audio channels.

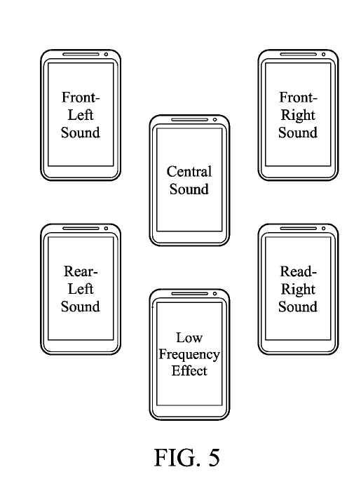

FIG. 5 depicts another exemplary embodiment of the invention, wherein speakers of six portable electronic devices are integrated. One of the six portable electronic devices may be a master device. The processor of the master device may integrate the speaker of the master device with the speakers of the nearby five portable electronic devices to display a 5.1 channel audio. In another exemplary embodiment, sound speakers of different portable electronic devices are integrated to just increase audio volume.

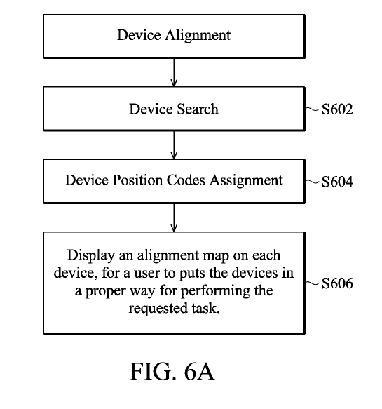

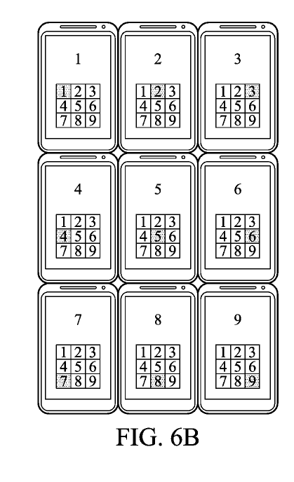

FIG. 6A is a flowchart depicting an alignment method between the different portable electronic devices. In step S602, a processor (e.g. 106 of FIG. 1) of a portable electronic device (100) controls the communication unit (102) to search for portable electronic devices nearby (e.g. 108). When detecting the nearby portable electronic device (108), step S604 is performed and the processor (106) of the portable electronic device (100) assigns a device position code to the portable electronic device (100) with respect to that assigned to the nearby portable electronic device (108). In step S606, the processor (106) of the portable electronic device (100) controls the touch panel (112) to display an alignment map corresponding to the device position code assigned to the portable electronic device (100) while a touch panel of the nearby portable electronic device (108) is controlled to display another alignment map corresponding to the device position code assigned to the nearby portable electronic device (108). According to the different alignment maps shown on the touch panels of the different portable electronic device s (100 and 108), a user can position the devices (100 and 108) in a proper way for performing the requested task.

FIG. 6B shows the different alignment maps displayed on 3×3 portable electronic devices. Device position codes assigned to the top three portable electronic devices are “1”, “2” and “3”. Device position codes assigned to the middle row of portable electronic devices are “4”, “5” and “6”. Device position codes assigned to the bottom three portable electronic devices are “7”, “8” and “9”. As shown, corresponding to the different device position codes assigned to the different portable electronic devices, different alignment maps are displayed on the different touch panels for a user to manually position the portable electronic devices in a 3×3 array.

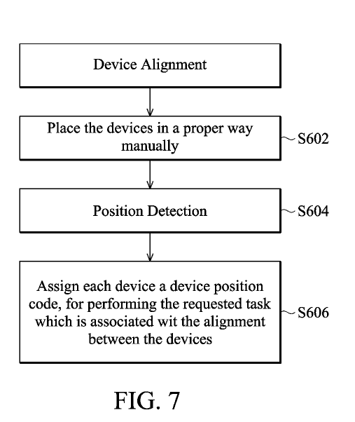

FIG. 7 shows a flowchart depicting an alignment method between the different portable electronic devices. In step S702, portable electronic devices are manually placed in a proper way with respect to each other (depending on the task to be performed by the integrated devices). In step S704, a positioned detection is performed to determine the position of each portable electronic device. According to the detection result of the device positions, different device position codes are assigned (e.g., by a processor of the master device between the devices) to the different portable electronic devices in step S706. According to the device positions codes, the portable electronic devices are integrated together to perform the requested task which is associated with the alignment between the portable electronic devices.

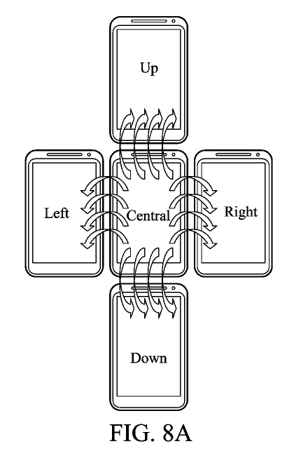

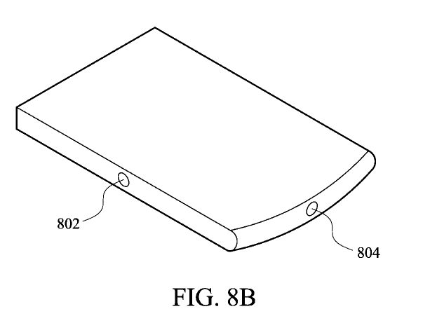

In an exemplary embodiment, the position detection of step S704 is implemented with touch panels (e.g. 112 of FIG. 1) of the portable electronic devices. FIG. 8A shows five portable electronic devices. The central portable electronic device is determined because four nearby portable electronic devices are detected by the four edges of the touch panel of the device. To improve the nearby device detection, the touch panel (112 of FIG. 1) may be manufactured to have high sensitivity edges. FIG. 8B shows another exemplary embodiment of a portable electronic device, wherein each edge of the touch panel is disposed with a transmitter (e.g. 802, 804), to be detected by a touch panel of a nearby portable electronic device.

In an exemplary embodiment, the nearby device detection results of all devices are collected and processed by the processor of the master device. As shown in FIG. 8A, a device with all edges adjacent to other devices is determined in the central position, a device only adjacent to another device on the left side is determined in the right position, a device only adjacent to another device on the right side is determined in the left position, a device only adjacent to another device on the down side is determined in the up position, and a device only adjacent to another device on the upside is determined in the down position.

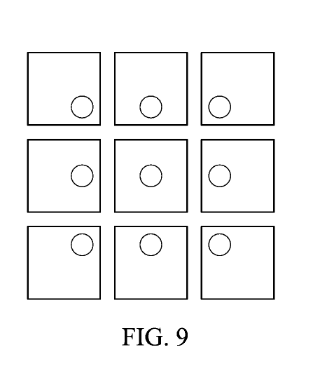

In another exemplary embodiment, the position detection of step S704 is implemented with cameras (e.g. 116 of FIG. 1) of the portable electronic devices. FIG. 9 shows 3×3 images captured by cameras of portable electronic devices arranged in a 3×3 array. As shown, an object is captured in the different images and shown in different locations of the images. By comparing the images, the position of each portable electronic device is determined. In some exemplary embodiments, compasses (e.g. 118 of FIG. 1) are used in direction unification between the different images.

The portable electronic devices may be smart phones, tablet computers, and so on.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A portable electronic device, comprising:
a communication unit, for communication between the portable electronic device and at least one nearby portable electronic device;
a storage media, stored with program codes of multi-device integration; and
a processor, executing the program codes for alignment and synchronization between the portable electronic device and the at least one nearby portable electronic device, to integrate the portable electronic device with the at least one nearby portable electronic device to perform a task associated with the alignment between the portable electronic device and the at least one nearby portable electronic device.

2. The portable electronic device as claimed in claim 1, further comprising a touch panel, wherein the processor integrates the touch panel of the portable electronic device with a touch panel of the at least one nearby portable electronic device for an enlarged screen.

3. The portable electronic device as claimed in claim 1, further comprising a touch panel, wherein the processor integrates the touch panel of the portable electronic device with a touch panel of the at least one nearby portable electronic device for keyboard extension, and the touch panel of the at least one nearby portable electronic device works as an extended keyboard.

4. The portable electronic device as claimed in claim 3, wherein the processor drives the touch panel of the portable electronic device to display a main screen while the touch panel of the at least one nearby portable electronic device is driven to display a keyboard pattern.

5. The portable electronic device as claimed in claim 1, further comprising a touch panel, wherein the processor integrates the touch panel of the portable electronic device with a touch panel of the at least one nearby portable electronic device for multimedia applications.

6. The portable electronic device as claimed in claim 1, further comprising a speaker, wherein the processor integrates the speaker of the portable electronic device with a speaker of the at least one nearby portable electronic device for an increased audio volume.

7. The portable electronic device as claimed in claim 1, further comprising a speaker, wherein the processor integrates the speaker of the portable electronic device with a speaker of the at least one nearby portable electronic device for multi-channel audio display.

8. The portable electronic device as claimed in claim 1, further comprising:
a touch panel,
wherein:
the processor controls the communication unit to detect the at least one nearby portable electronic device and, when detecting the at least one nearby portable electronic device, the processor assigns a device position code to the portable electronic device with respect to that assigned to the at least one nearby portable electronic device; and
the processor controls the touch panel to display an alignment map corresponding to the device position code assigned to the portable electronic device, for a user to manually position the portable electronic device to align with the nearby portable electronic device.

9. The portable electronic device as claimed in claim 1, further comprising:
a touch panel, controlled by the processor to detect the at least one nearby portable electronic device by edge detection, and thereby the processor assigns a device position code to the portable electronic device with respect to that assigned to the at least one nearby portable electronic device,
wherein the processor operates the portable electronic device according to the device position code assigned to the portable electronic device for performing the task with the at least one nearby portable electronic device.

10. The portable electronic device as claimed in claim 9, wherein the touch panel further comprises transmitters disposed on different edges of the touch panel to be detected by a touch panel of the at least one nearby portable electronic device.

11. The portable electronic device as claimed in claim 1, further comprising:
a camera; and
wherein:
by comparing an image captured by the camera with another image captured by a camera of the at least one nearby portable electronic device, the processor assigns a device position code to the portable electronic device with respect to that assigned to the at least one nearby portable electronic device; and
the processor operates the portable electronic device according to the device position code assigned to the portable electronic device for performing the task with the at least one nearby portable electronic device.

12. The portable electronic device as claimed in claim 11, further comprising:
a compass, for direction unification between the image captured by the camera of the portable electronic device and the another image captured by the camera of the at least one nearby portable electronic device.

13. A multi-device integration method, comprising:
using a processor of a portable electronic device to execute program codes of multi-device integration; and
according to the executed program codes, aligning and synchronizing the portable electronic device to at least one nearby portable electronic device and thereby integrating the portable electronic device with the at least one nearby portable electronic device to perform a task associated with an alignment between the portable electronic device and the at least one nearby portable electronic device.

14. The method as claimed in claim 13, comprising:
integrating a touch panel of the portable electronic device with a touch panel of the at least one nearby portable electronic device for an enlarged screen.

15. The method as claimed in claim 13, comprising:
integrating a touch panel of the portable electronic device with a touch panel of the at least one nearby portable electronic device for keyboard extension, by which the touch panel of the at least one nearby portable electronic device is operated as an extended keyboard.

16. The method as claimed in claim 15, comprising:
driving the touch panel of the portable electronic device to display a main screen when the touch panel of the at least one nearby portable electronic device is driven to display a keyboard pattern.

17. The method as claimed in claim 13, comprising:
integrating a touch panel of the portable electronic device with a touch panel of the at least one nearby portable electronic device for multimedia applications.

18. The method as claimed in claim 13, comprising:
integrating a speaker of the portable electronic device with a speaker of the at least one nearby portable electronic device for an increased audio volume.

19. The method as claimed in claim 13, comprising:
integrating a speaker of the portable electronic device with a speaker of the at least one nearby portable electronic device for multi-channel audio display.

20. The method as claimed in claim 13, comprising:
controlling a communication unit of the portable electronic device to detect the at least one nearby portable electronic device and, when detecting the at least one nearby portable electronic device, assigning a device position code to the portable electronic device with respect to that assigned to the at least one nearby portable electronic device; and
controlling a touch panel of the portable electronic device to display an alignment map corresponding to the device position code assigned to the portable electronic device, for a user to manually position the portable electronic device to align with the at least one nearby portable electronic device.

21. The method as claimed in claim 13, comprising:
controlling a touch panel of the portable electronic device to detect the at least one nearby portable electronic device by edge detection and, accordingly, assigning a device position code to the portable electronic device with respect to that assigned to the at least one nearby portable electronic device; and
controlling the portable electronic device according to the device position code assigned to the portable electronic device for performing the task with the at least one nearby portable electronic device.

22. The method as claimed in claim 21, comprising:
controlling the touch panel of the portable electronic device to detect a transmitter emission from a transmitter disposed on an edge of a touch panel of the at least one nearby portable electronic device, by which an edge of the portable electronic device adjacent to the at least one nearby portable electronic device is determined.

23. The method as claimed in claim 13, comprising:
comparing an image captured by a camera of the portable electronic device with another image captured by a camera of the at least one nearby portable electronic device and, accordingly, assigning a device position code to the portable electronic device with respect to that assigned to the at least one nearby portable electronic device;
controlling the portable electronic device according to the device position code assigned to the portable electronic device for performing the task with the at least one nearby portable electronic device.

24. The method as claimed in claim 13, comprising:
unifying directions of the image and the another image by a compass of the portable electronic device.
